(19) United States
(12) Patent Application Publication
(10) Pub. No.: US 2024/0311820 A1
(43) Pub. Date: Sep. 19, 2024

(54) DATA PROCESSING

(71) Applicant: Alipay (Hangzhou) Information Technology Co., Ltd., Hangzhou (CN)

(72) Inventors: Kun WU, Hangzhou (CN); Yang ZHANG, Hangzhou (CN); Xiangjian SHI, Hangzhou (CN); Wenhu KAN, Hangzhou (CN); Yue WANG, Hangzhou (CN); Chen SHU, Hangzhou (CN)

(21) Appl. No.: 18/563,828

(22) PCT Filed: Jul. 4, 2022
(86) PCT No.: PCT/CN2022/103553

§ 371 Date: Nov. 22, 2023

(30) Foreign Application Priority Data
May 28, 2021 (CN) 202110593258.7

(51) Int. Cl. G06Q 20/38; G06Q 20/04; G06Q 20/20

(52) U.S. Cl. CPC G06Q 20/389; G06Q 20/047; G06Q 20/209

(57) ABSTRACT

Embodiments of this specification provide a data processing method, apparatus, device, and system. The method includes: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

### TECHNICAL FIELD

This document relates to the field of data processing technologies, and in particular, to a data processing method, apparatus, device, and system.

### BACKGROUND

With development of Internet technologies, an electronic invoice replaces a paper invoice in many scenarios. For example, in a reimbursement scenario of an enterprise employee, because it is more convenient to issue and store the electronic invoice than the paper invoice, most enterprise employees choose to issue an electronic invoice after business consumption. After issuing an electronic invoice, a merchant sends the electronic invoice to a personal mailbox designated by the enterprise employee. During reimbursement, the enterprise employee prints the electronic invoice, fills in a reimbursement application form, pastes a printed paper invoice, and submits the paper invoice to an auditor. The auditor performs an audit operation such as verifying authenticity of the invoice, and makes reimbursement after audit succeeds. An entire reimbursement process is cumbersome, and a large amount of time and energy of the enterprise employee and the auditor need to be consumed.

### SUMMARY

One or more embodiments of this specification provide a data processing method. The method includes: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

One or more embodiments of this specification provide a data processing apparatus. The apparatus includes a determining module, configured to determine a receipt obtaining manner corresponding to a payment voucher. The payment voucher is generated after payment processing of a target transaction is performed based on a reimbursement code. The apparatus further includes an obtaining module, configured to obtain, in the receipt obtaining manner, an electronic receipt that matches the payment voucher. The apparatus further includes a return module, configured to return the electronic receipt and the payment voucher to an application platform on which an institution to which the reimbursement code belongs is settled, to process the electronic receipt and the payment voucher on the application platform.

One or more embodiments of this specification provide a data processing system. The system includes a data processing platform, configured to: determine a receipt obtaining manner corresponding to a payment voucher, where the payment voucher is generated after payment processing of a target transaction is performed based on a reimbursement code; obtain, in the receipt obtaining manner, an electronic receipt that matches the payment voucher; and return the electronic receipt and the payment voucher to an application platform on which an institution to which the reimbursement code belongs is settled. The application platform receives the electronic receipt and the payment platform that are returned by the data platform, and processes the electronic receipt and the payment voucher.

One or more embodiments of this specification provide a data processing device. The device includes a processor. The device further includes a storage, configured to store computer-executable instructions. When the computer-executable instructions are executed, the processor is enabled to perform the following operations: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

One or more embodiments of this specification provide a storage medium. The storage medium is configured to store computer-executable instructions. When the computer-executable instructions are executed by a processor, the processor is enabled to perform the following operations: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

### BRIEF DESCRIPTION OF DRAWINGS

To describe the technical solutions in one or more embodiments of this specification or in the conventional technology more clearly, the following briefly describes the accompanying drawings needed for describing the embodiments or the conventional technology. Clearly, the accompanying drawings in the following description merely show some embodiments of this specification, and a person of ordinary skill in the art can still derive other drawings from these accompanying drawings without creative efforts.

FIG. 1 is a schematic diagram illustrating a scenario of a data processing method, according to one or more embodiments of this specification;

FIG. 2 is a first schematic flowchart illustrating a data processing method, according to one or more embodiments of this specification;

FIG. 3 is a second schematic flowchart illustrating a data processing method, according to one or more embodiments of this specification;

FIG. 4 is a third schematic flowchart illustrating a data processing method, according to one or more embodiments of this specification;

FIG. 5 is a fourth schematic flowchart illustrating a data processing method, according to one or more embodiments of this specification;

FIG. 6 is a fifth schematic flowchart illustrating a data processing method, according to one or more embodiments of this specification;

FIG. 7 is a sixth schematic flowchart illustrating a data processing method, according to one or more embodiments of this specification;

FIG. 8 is a seventh schematic flowchart illustrating a data processing method, according to one or more embodiments of this specification;

FIG. 9 is an eighth schematic flowchart illustrating a data processing method, according to one or more embodiments of this specification;

FIG. 10 is a schematic diagram illustrating a module composition of a data processing apparatus, according to one or more embodiments of this specification;

FIG. 11 is a schematic diagram illustrating a composition of a data processing system, according to one or more embodiments of this specification; and

FIG. 12 is a schematic diagram illustrating a structure of a data processing device, according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

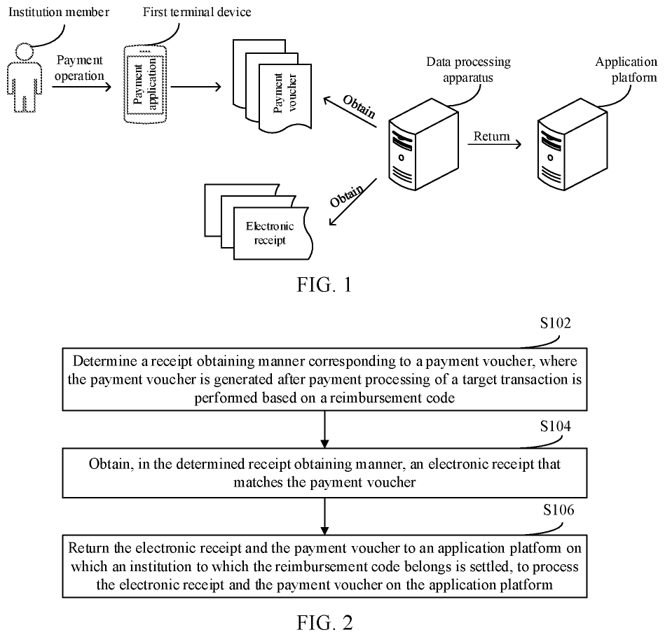

FIG. 1 is a schematic diagram illustrating an application scenario of a data processing method, according to one or more embodiments of this specification. As shown in FIG. 1, the scenario includes: a first terminal device of an institution member who performs a payment operation based on a reimbursement code, a data processing apparatus, and an institution to which a reimbursement code belongs. The reimbursement code can be in any form, for example, a two-dimensional code, a barcode, or a string. The institution can be an enterprise, a public institution, a social organization, an organization, etc. The first terminal device can be a mobile phone, a tablet computer, a desktop computer, a notebook computer, a smart watch, etc. (only the mobile phone is shown in FIG. 1). A payment application is installed in the first terminal device. The payment application can be an independent application (Application, App for short), can be a mini program embedded in another application, or can be a web-based application. The data processing apparatus can be an independent server, or can be a server cluster including a plurality of servers. An application platform can be an application deployed in a third terminal device of the institution, and a full-time member in the institution member operates the application platform to process an electronic receipt. The application platform can alternatively be a third-party entity platform independent of the institution, and is configured to provide the institution with an electronic receipt processing service, for example, a reimbursement service.

Specifically, the institution pre-configures the reimbursement code for the institution member of the institution. When the institution member pays for at least one target transaction on business (for example, a business trip, a team building, or office procurement), the payment application in the first terminal device of the institution can be operated to perform a payment operation based on the reimbursement code, and a payment server corresponding to the payment application generates a corresponding payment voucher in an electronic form. A transaction participant of the target transaction generates a corresponding payment voucher in an electronic form or a paper form. The data processing apparatus determines a corresponding receipt obtaining manner for the payment voucher of the target transaction; obtains, in the determined receipt obtaining manner, an electronic receipt that matches the payment voucher; and returns the obtained electronic receipt and the payment voucher to an application platform on which the institution to which the reimbursement code belongs is settled, to process the electronic receipt and the payment voucher on the application platform. The transaction participant can be an online merchant, an offline merchant, a service platform (for example, a receipting platform), etc., or can be another type of transaction participant. The electronic receipt includes the receipt voucher in the electronic form, for example, an electronic invoice, and can further include a receipt voucher that is in an electronic form and that is obtained by performing an operation such as photographing or scanning on the receipt voucher in the paper form, for example, a train receipt photo. The data processing apparatus can be disposed in the payment server, or can be separated from the payment server and exist independently.

Further, a manner in which the institution pre-configures the reimbursement code for the institution member of the institution can be set based on a requirement in an actual application. For example, the institution can apply for the reimbursement code from the payment server corresponding to the payment application in advance, and provide the applied reimbursement code to each institution member of the institution. Each institution member operates a payment application of the institution member to complete binding of the reimbursement code. Correspondingly, when performing a payment operation, the institution member can directly perform payment based on the reimbursement code bound to the payment application. For another example, the institution sends member information of each institution member to the payment server corresponding to the payment application, and the payment server performs binding processing on the received member information and an allocated reimbursement code, and stores the received member information and the allocated reimbursement code in a specified database in an association manner. Correspondingly, when operating the payment application to perform a payment operation, the institution member can obtain the bound reimbursement code from the payment server, and perform payment based on the obtained reimbursement code.

In this way, an electronic receipt that matches a payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

Based on an architecture of the application scenario, one or more embodiments of this specification provide a data processing method. FIG. 2 is a schematic flowchart illustrating a data processing method, according to one or more embodiments of this specification. The method in FIG. 2 can be performed by the data processing apparatus in FIG. 1. As shown in FIG. 2, the method includes the following steps.

Step S102: Determine a receipt obtaining manner corresponding to a payment voucher, where the payment voucher is generated after payment processing of a target transaction is performed based on a reimbursement code.

Optionally, when payment voucher processing information is obtained, the corresponding payment voucher is obtained, and a receipt obtaining manner corresponding to the obtained payment voucher is determined. Specifically, when the data processing apparatus is separated from a payment server corresponding to a payment application and exists independently, if the payment server determines that an institution member performs a payment operation for a target transaction based on the reimbursement code, the payment server generates a payment voucher after payment processing, stores the payment voucher in a specified payment voucher library, and sends payment voucher processing information to the data processing apparatus based on voucher identification information of the payment voucher. The data processing apparatus obtains the corresponding payment voucher from the payment voucher library based on the voucher identification information in the processing information, and determines a receipt obtaining manner of the obtained payment voucher. Alternatively, after performing payment processing, a payment server generates a payment voucher, stores the payment voucher in a specified payment voucher library, and sends voucher information such as voucher identification information, a payment amount, and a payment time period of the payment voucher to a payment application. The payment application displays corresponding voucher information and a reimbursement button in response to a payment record query operation performed by an institution member, and sends payment voucher processing information to the data processing apparatus based on the determined voucher identification information in response to a reimbursement operation performed by the institution member, that is, an operation performed on the reimbursement button. The data processing apparatus obtains the corresponding payment voucher from the payment voucher library based on the voucher identification information in the processing information, and determines a receipt obtaining manner corresponding to the obtained payment voucher. When the data processing apparatus is disposed in the payment server, after the payment server generates the payment voucher, an electronic voucher processing apparatus can obtain corresponding processing information and obtain the corresponding payment voucher.

Alternatively, each payment voucher whose generation time point falls within a corresponding second time interval and that is associated with a preset identifier is obtained from a specified payment voucher library at a preset second time interval; or a corresponding receipt obtaining manner is determined for each obtained payment voucher. Specifically, if a payment server determines that an institution member performs a payment operation for a target transaction based on the reimbursement code, the payment server generates a payment voucher after payment processing, and stores the payment voucher and a preset identifier in a specified payment voucher library in an association manner. The data processing apparatus obtains, from the payment voucher library at the preset second time interval, each payment voucher whose generation time point falls within a corresponding second time interval and that is associated with the preset identifier, and determines a receipt obtaining manner corresponding to each payment voucher. The preset identifier can be the reimbursement code, or another identifier that indicates to perform payment based on the reimbursement code.

The payment voucher can include the voucher identification information, the payment amount, the payment time point, participant information of a transaction participant, etc.

Step S104: Obtain, in the determined receipt obtaining manner, an electronic receipt that matches the payment voucher. In consideration that receipt vouchers of different transaction participants may be provided in different manner, this specification provides a plurality of receipt obtaining manners. The data processing apparatus obtains, in the receipt obtaining manner corresponding to the payment voucher, the electronic receipt that matches the payment voucher.

Step S106: Return the electronic receipt and the payment voucher to an application platform on which an institution to which the reimbursement code belongs is settled, to process the electronic receipt and the payment voucher on the application platform.

When the application platform is an application deployed in a third terminal device of the institution, a full-time member of a related position in the institution member can operate the application platform, and process the electronic receipt and the payment voucher on the application platform, for example, perform reimbursement processing. When the application platform is a third-party entity platform independent of the institution, the application platform can process the received electronic receipt and the received payment voucher, for example, perform reimbursement processing, and send the electronic receipt and the payment voucher to the corresponding institution after processing is completed, so that the institution can keep the electronic receipt and the payment voucher for a record.

In one or more embodiments of this specification, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

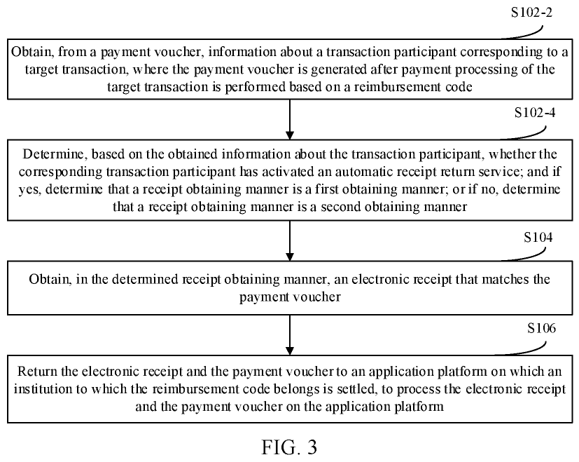

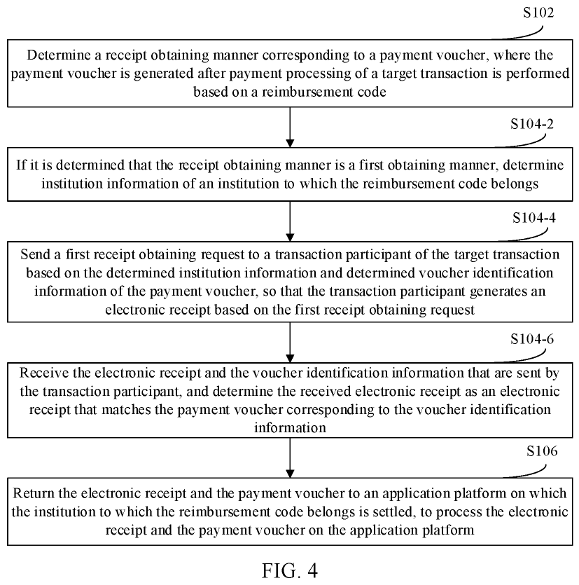

To improve electronic receipt obtaining efficiency, in one or more embodiments of this specification, the data processing apparatus can pre-communicate with the transaction participant, and obtain an automatic receipt return service from the transaction participant. In other words, the transaction participant returns, to the data processing apparatus, the electronic receipt associated with the payment voucher. However, in consideration that in an actual application, not all transaction participants are capable of providing an automatic receipt return service, the data processing apparatus first determines an electronic receipt processing manner corresponding to the payment voucher. Specifically, as shown in FIG. 3, step S102 can include step S102-2 and step S102-4.

Step S102-2: Obtain, from the payment voucher, information about the transaction participant corresponding to the target transaction, where the payment voucher is generated after payment processing of the target transaction is performed based on the reimbursement code.

Step S102-4: Determine, based on the obtained information about the transaction participant, whether the corresponding transaction participant has activated an automatic receipt return service; and if yes, determine that the receipt obtaining manner is a first obtaining manner; or if no, determine that the receipt obtaining manner is a second obtaining manner.

Specifically, an associated service providing identifier is obtained from a specified information table based on the obtained information about the transaction participant. If the obtained service providing identifier indicates to provide the automatic receipt return service, it is determined that the receipt obtaining manner is the first obtaining manner; or if the obtained service providing identifier indicates not to provide the automatic receipt return service, it is determined that the receipt obtaining manner is the second obtaining manner.

Further, when the receipt obtaining manner is the first obtaining manner, as shown in FIG. 4, step S104 can include step S104-2 to step S104-6.

Step S104-2: If it is determined that the receipt obtaining manner is the first obtaining manner, determine institution information of the institution to which the reimbursement code belongs.

Specifically, when the payment voucher library includes an association relationship between the payment voucher and the reimbursement code, the data processing apparatus can obtain the payment voucher and the associated reimbursement code from the payment voucher library; obtain associated institution information from a preset association relationship between the reimbursement code and institution information based on the obtained reimbursement code; and determine the obtained institution information as the institution information of the institution to which the reimbursement code belongs. When the payment voucher library does not include an association relationship between the payment voucher and the reimbursement code, the data processing apparatus can obtain associated institution information from a preset association relationship between member information and institution information based on member information of an institution member corresponding to the payment voucher, and determine the obtained institution information as institution information of the institution to which the reimbursement code belongs; or determine, based on the member information, a reimbursement code bound to a corresponding member, obtain associated institution information from a preset association relationship between the reimbursement code and the institution information based on the reimbursement code, and determine the obtained institution information as institution information of the institution to which the reimbursement code belongs.

Step S104-4: Send a first receipt obtaining request to the transaction participant of the target transaction based on the determined institution information and the determined voucher identification information of the payment voucher, so that the transaction participant generates the electronic receipt based on the first receipt obtaining request.

Specifically, the first receipt obtaining request is sent to a second terminal device of the transaction participant of the target transaction based on the determined institution information and the determined voucher identification information of the payment voucher. The second terminal device obtains transaction information of the corresponding target transaction based on the voucher identification information in the first receipt obtaining request, generates the electronic receipt based on the transaction information, and sends the generated electronic receipt and the voucher identification information to the data processing apparatus.

Step S104-6: Receive the electronic receipt and the voucher identification information that are sent by the transaction participant, and determine the received electronic receipt as the electronic receipt that matches the payment voucher corresponding to the voucher identification information.

Therefore, when it is determined that the receipt obtaining manner is the first obtaining manner, that is, when the transaction participant provides the automatic receipt return service, the first receipt obtaining request is actively sent to the transaction participant, to obtain the electronic receipt. In this process, an institution member corresponding to the target transaction does not need to perform any operation. Therefore, the receipt is automatically returned to the application platform when the institution member is insensitive, to not only improve experience of the institution member, but also improve receipt return efficiency. In the reimbursement scenario, reimbursement efficiency is greatly improved.

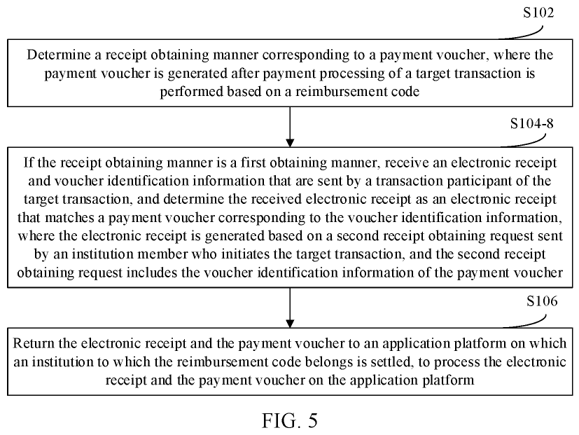

The reimbursement scenario is used as an example for description. In consideration that the institution may adjust a reimbursement system, electronic receipts of some target transactions based on the reimbursement code cannot participate in reimbursement. To improve accuracy of an electronic receipt sent to the application platform, in one or more embodiments of this specification, as shown in FIG. 5, when the receipt obtaining manner is the first obtaining manner, step S104 can include step S104-8: If the receipt obtaining manner is the first obtaining manner, receive the electronic receipt and the voucher identification information that are sent by the transaction participant of the target transaction, and determine the received electronic receipt as the electronic receipt that matches the payment voucher corresponding to the voucher identification information, where the electronic receipt is generated based on a second receipt obtaining request sent by an institution member who initiates the target transaction, and the second receipt obtaining request includes the voucher identification information of the payment voucher.

Specifically, when the institution member of the target transaction performs the payment operation based on the reimbursement code by using the payment application, the payment server performs payment processing and generates the payment voucher, and then sends the voucher information of the payment voucher to the payment application. The payment application displays the voucher information and a corresponding receipt application button in response to the payment record query operation performed by the institution member; and in response to a receipt application operation performed by the institution member, that is, an operation performed on the receipt application button, for example, tapping or double tapping, sends the second receipt obtaining request to the second terminal device of the transaction participant based on the determined voucher identification information of the payment voucher and the institution information. The second terminal device queries corresponding transaction information of the target transaction based on the voucher identification information in the second receipt obtaining request, generates the electronic receipt based on the transaction information, sends the generated electronic receipt and the voucher identification information in the second receipt obtaining request to the data processing apparatus, and sends request success information to the payment application.

Therefore, when it is determined that the receipt obtaining manner is the first obtaining manner, that is, when the transaction participant provides the automatic receipt return service, the electronic receipt sent by the transaction participant based on the second receipt obtaining request sent by the institution member is received, so that the institution member can independently choose, based on a requirement of the institution member, whether to generate the electronic receipt. In this way, a reimbursement requirement of the institution member can be met. In addition, the institution member only needs to perform a simple operation in the payment application, without a need to occupy too much time and energy of the institution member. Therefore, experience of the institution member can be improved when the receipt is automatically returned to the application platform.

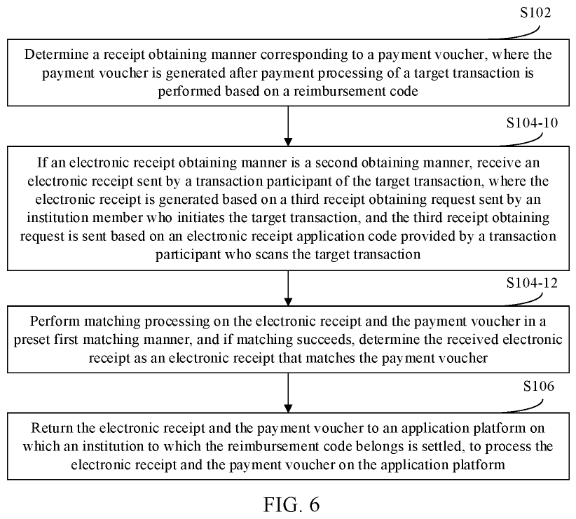

Further, when the transaction participant of the target transaction does not provide the automatic receipt return service associated with the payment voucher, a direct receipt return service can be further provided based on a request of the institution member. In other words, a receipt return service not associated with the electronic receipt or the payment voucher is provided. Specifically, as shown in FIG. 6, when an electronic receipt obtaining manner is the second obtaining manner, step S104 can include step S104-10 and step S104-12.

Step S104-10: If the electronic receipt obtaining manner is the second obtaining manner, receive the electronic receipt sent by the transaction participant of the target transaction, where the electronic receipt is generated based on a third receipt obtaining request sent by the institution member who initiates the target transaction, and the third receipt obtaining request is sent based on an electronic receipt application code provided by the transaction participant who scans the target transaction.

Specifically, the transaction participant (for example, a merchant) of the target transaction provides an electronic receipt application code, for example, a two-dimensional code. After the payment operation performed by the institution member who initiates the target transaction succeeds, the payment application can be operated to scan the electronic receipt application code, receipt insurance information such as institution information and a payment amount is input, and the payment application sends the third receipt obtaining request to the second terminal device of the transaction participant of the target transaction based on information such as the receipt insurance information and an application identifier of the payment application. The second terminal device generates the corresponding electronic receipt based on the third receipt obtaining request, determines an associated data processing apparatus based on the application identifier, sends request success information to a first terminal device, and sends an electronic receipt to a data processing apparatus, to implement the direct receipt return service. The data processing apparatus receives the electronic receipt sent by the second terminal device.

Step S104-12: Perform matching processing on the electronic receipt and the payment voucher in a preset first matching manner, and if matching succeeds, determine the received electronic receipt as the electronic receipt that matches the payment voucher.

The first matching manner can be set based on a requirement in an actual application. For example, information extraction processing is separately performed on the electronic receipt and the payment voucher, to obtain corresponding first key information and second key information; and matching processing is performed on the first key information and the second key information, to obtain a similarity between the first key information and the second key information. If it is determined that the similarity is greater than a similarity threshold, it is determined that the electronic receipt and the payment voucher match. The first key information includes a payment amount, information of an electronic receipt provider (for example, merchant information), etc., and the second key information includes a payment amount, participant information of the transaction participant, etc.

Therefore, when the transaction participant of the target transaction provides the direct receipt return service, the institution member who initiates the target transaction can perform code scanning and receipt return based on a requirement, without requiring the institution member to perform processing such as offline receipt pasting, so that not only the electronic receipt is automatically returned, but also experience of the institution member can be improved.

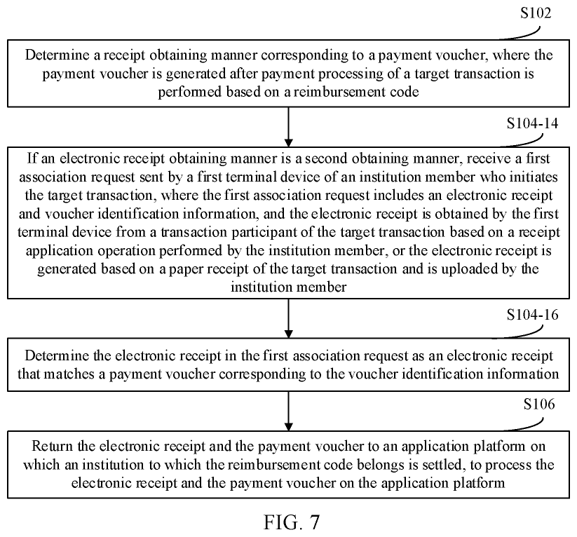

In consideration that in an actual application, some transaction participants may not communicate with the data processing apparatus or provide only paper receipts, in one or more embodiments of this specification, as shown in FIG. 7, step S104 can include step S104-14 and step S104-16.

Step S104-14: If the electronic receipt obtaining manner is the second obtaining manner, receive a first association request sent by the first terminal device of the institution member who initiates the target transaction, where the first association request includes the electronic receipt and the voucher identification information, and the electronic receipt is obtained by the first terminal device from the transaction participant of the target transaction based on a receipt application operation performed by the institution member, or the electronic receipt is generated based on a paper receipt of the target transaction and is uploaded by the institution member.

Specifically, the transaction participant (for example, the merchant) of the target transaction provides the electronic receipt application code, for example, the two-dimensional code. After the payment operation performed by the institution member who initiates the target transaction succeeds, the payment application in the first terminal device of the institution member can be operated to scan the electronic receipt application code, receipt insurance information such as the institution information and the payment amount is input, and a receiving address of the electronic receipt (for example, a personal mailbox of the institution member) is specified. The payment application sends a fourth receipt obtaining request to the second terminal device of the transaction participant based on the receipt insurance information and the receiving address. The second terminal device generates the corresponding electronic receipt based on the receipt insurance information in the fourth receipt obtaining request, and sends the electronic receipt to the receiving address. Alternatively, when a transaction provider provides a paper receipt to the institution member, the institution member photographs or scans the paper receipt, etc., to obtain a corresponding electronic receipt. The payment application in the first terminal device displays the voucher information of the payment voucher and a corresponding uploading button in response to the payment record query operation performed by the institution member; in response to an operation performed by the institution member on the uploading button, obtains the electronic receipt in the receiving address uploaded by the institution member or obtain the electronic receipt that is obtained based on the paper receipt and that is uploaded by the institution member; determines the voucher identification information of the corresponding payment voucher; and sends the first association request to the data processing apparatus based on the obtained electronic receipt and the determined voucher identification information.

Step S106-16: Determine the electronic receipt in the first association request as the electronic receipt that matches the payment voucher corresponding to the voucher identification information.

Therefore, in the payment application, the uploading button is disposed in correspondence with the voucher information of the payment voucher. When the transaction participant does not communicate with the data processing apparatus or the transaction participant does not provide the electronic receipt, the institution member can operate the uploading button to upload the corresponding electronic receipt, to implement automatic receipt return by using a simple operation, without a need to perform an operation such as offline receipt pasting, so that not only experience of the institution member can be improved, but also reimbursement efficiency is improved.

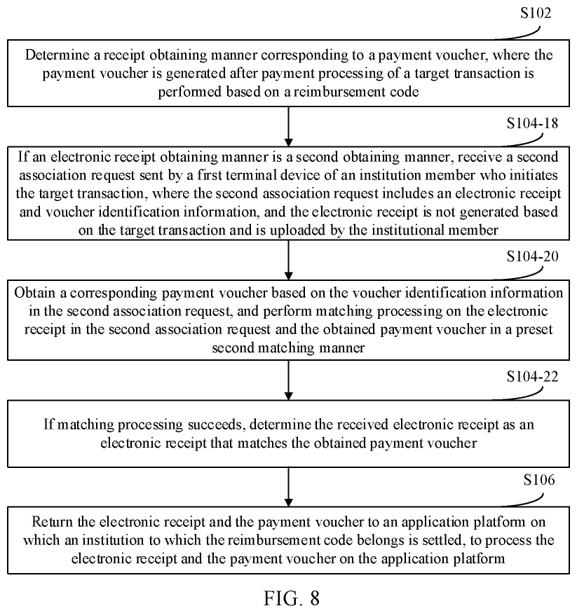

Further, in consideration that in an actual application, some transaction participants may not provide a receipt voucher, when the institution member is allowed to pool receipts, the institution member can further upload an electronic receipt obtained based on another transaction. Specifically, as shown in FIG. 8, step S104 can include step S104-18 to step S104-22.

Step S104-18: If the electronic receipt obtaining manner is the second obtaining manner, receive a second association request sent by the first terminal device of the institution member who initiates the target transaction, where the second association request includes the electronic receipt and the voucher identification information, and the electronic receipt is not generated based on the target transaction and is uploaded by the institutional member.

Specifically, when the transaction participant does not provide a receipt voucher, that is, does not provide any electronic receipt or any paper receipt, the institution member can obtain the electronic receipt based on another transaction. In other words, the electronic receipt is not generated based on the target transaction. Similarly, the payment application in the first terminal device displays the voucher information of the payment voucher and a corresponding uploading button in response to the payment record query operation performed by the institution member; in response to an uploading operation performed by the institution member, that is, an operation performed on the uploading button, obtains the electronic receipt that is not based on the target transaction and that is uploaded by the institution member; determines the voucher identification information of the corresponding payment voucher; and sends the second association request to the data processing apparatus based on the obtained electronic receipt and the determined voucher identification information.

Step S104-20: Obtain a corresponding payment voucher based on the voucher identification information in the second association request, and perform matching processing on the electronic receipt in the second association request and the obtained payment voucher in a preset second matching manner. The second matching manner can be the same as or different from the first matching manner, and can be set based on a requirement in an actual application.

Step S104-22: If matching processing succeeds, determine the received electronic receipt as the electronic receipt that matches the obtained payment voucher.

Therefore, when receipts are allowed to be pooled, the institution member can operate the uploading button in the payment application to upload the corresponding electronic receipt, to implement automatic receipt return by using a simple operation, without a need to perform an operation such as offline receipt pasting, so that not only experience of the institution member can be improved, but also reimbursement efficiency is improved.

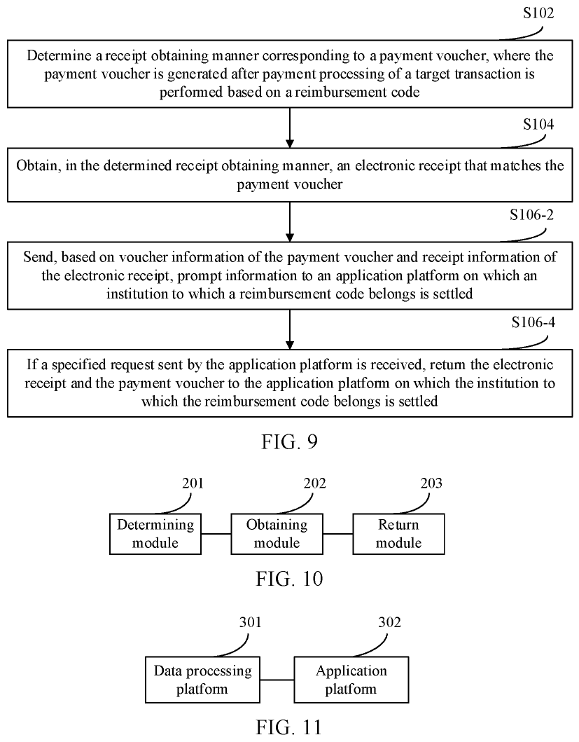

In one or more embodiments of this specification, prompt information can be first sent to the application platform, so that the application platform can process the electronic receipt and the payment voucher in sequence. Specifically, as shown in FIG. 9, step S106 can include step S106-2 and step S106-4.

Step S106-2: Send, based on the voucher information of the payment voucher and the receipt information of the electronic receipt, prompt information to the application platform on which the institution to which the reimbursement code belongs is settled.

Specifically, an association relationship between the electronic receipt and the payment voucher is established at a preset first time interval based on receipt information of each electronic receipt obtained in the corresponding first time interval and voucher information of a matching payment voucher; and the prompt information is sent, based on the established association relationship, to the application platform on which the institution to which the reimbursement code belongs is settled. The receipt information is, for example, receipt identification information, and the voucher information is, for example, voucher identification information.

Step S106-4: If a specified request sent by the application platform is received, return the electronic receipt and the payment voucher to the application platform on which the institution to which the reimbursement code belongs is settled.

Specifically, the application platform can include a downloading button. The application platform sends a downloading request to the data processing apparatus in response to an operation performed by the user on the downloading button. The data processing apparatus performs downloading processing on the corresponding electronic receipt and payment voucher based on the received downloading request, to return the electronic receipt and the payment voucher to the application platform. Alternatively, the application platform can include a receipt obtaining button. The application platform sends the receipt obtaining request to the data processing apparatus in response to an operation performed by the user on the receipt obtaining button. The data processing apparatus sends the corresponding electronic receipt and payment voucher to the application platform based on the received receipt obtaining request.

Further, in one or more embodiments of this specification, when performing configuration processing on the reimbursement code, the institution can further specify a payment account of the institution, so that reimbursement efficiency is improved, and the institution member does not need to prepay funds. The payment server stores the payment account and the allocated reimbursement code in an association manner, and when it is determined that the payment operation performed by the institution member is performed based on the reimbursement code, determines a payment account associated with the reimbursement code, and performs payment processing based on the determined payment account. The payment account can be a savings account, a credit account, etc. Therefore, integrated processing of payment and reimbursement can be implemented based on the reimbursement code, and the institution member does not need to prepay funds, so that reimbursement efficiency can be improved, and experience of the institution member can be greatly improved.

In one or more embodiments of this specification, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

Corresponding to the described data processing method, based on a same technical concept, one or more embodiments of this specification further provide a data processing apparatus. FIG. 10 is a schematic diagram illustrating a module composition of a data processing apparatus, according to one or more embodiments of this specification. As shown in FIG. 10, the apparatus includes: a determining module 201, configured to determine a receipt obtaining manner corresponding to a payment voucher, where the payment voucher is generated after payment processing of a target transaction is performed based on a reimbursement code; an obtaining module 202, configured to obtain, in the receipt obtaining manner, an electronic receipt that matches the payment voucher; and a return module 203, configured to return the electronic receipt and the payment voucher to an application platform on which an institution to which the reimbursement code belongs is settled, to process the electronic receipt and the payment voucher on the application platform.

Optionally, the determining module 201 is configured to: obtain information about a transaction participant corresponding to the target transaction from the payment voucher; determine, based on the information about the transaction participant, whether the transaction participant has activated an automatic receipt return service; and if yes, determine that the receipt obtaining manner is a first obtaining manner; or if no, determine that the receipt obtaining manner is a second obtaining manner.

According to the data processing apparatus provided in one or more embodiments of this specification, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

It is worthwhile to note that the embodiment of the data processing apparatus in this specification is based on the same inventive concept as the embodiment of the data processing method in this specification. Therefore, for specific implementation of the embodiment, references can be made to the above-mentioned corresponding implementation of the data processing method, and repeated parts are omitted for simplicity.

Further, corresponding to the described data processing method, based on a same technical concept, one or more embodiments of this specification further provide a data processing system. FIG. 11 is a schematic diagram illustrating a composition of a data processing system, according to one or more embodiments of this specification. As shown in FIG. 11, the system includes a data processing platform 301 and an application platform 302. The data processing platform 301 is configured to: determine a receipt obtaining manner corresponding to a payment voucher, where the payment voucher is generated after payment processing of a target transaction is performed based on a reimbursement code; obtain, in the receipt obtaining manner, an electronic receipt that matches the payment voucher; and return the electronic receipt and the payment voucher to an application platform 302 on which an institution to which the reimbursement code belongs is settled. The application platform 302 receives the electronic receipt and the payment platform that are returned by the data platform 301, and processes the electronic receipt and the payment voucher.

Optionally, the system further includes: a first terminal device of an institution member of the institution who initiates the target transaction, and a second terminal device of a transaction participant of the target transaction. The data processing platform 301 is configured to: determine institution information of the institution based on the reimbursement code if it is determined that the receipt obtaining manner is a first obtaining manner; send a first receipt obtaining request to the second terminal device based on the institution information and determined voucher identification information of the payment voucher; receive the electronic receipt and the voucher identification information that are sent by the second terminal device; and determine the electronic receipt as the electronic receipt that matches the payment voucher corresponding to the voucher identification information. The second terminal device receives the first receipt obtaining request sent by the data processing platform 301, generates the electronic receipt based on the first receipt obtaining request, and sends the electronic receipt and the voucher identification information to the data processing platform.

Alternatively, the first terminal device displays voucher information of a corresponding payment voucher in response to a payment record query operation of the institution member; sends a second receipt obtaining request to the second terminal device based on determined voucher identification information of the payment voucher and institution information of the institution in response to a receipt application operation performed by the institution member based on the voucher information; and receives request success information sent by the second terminal device. The second terminal device generates the electronic receipt based on the second receipt obtaining request, sends the electronic receipt and the voucher identification information to the data processing platform 301, and sends request success information to the first terminal device. The data processing platform 301 is configured to: if it is determined that the receipt obtaining manner is a first obtaining manner and the electronic receipt and the voucher identification information that are sent by the second terminal device are received, determine the received electronic receipt as the electronic receipt that matches the payment voucher corresponding to the voucher identification information.

According to the data processing system provided in one or more embodiments of this specification, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

It is worthwhile to note that the embodiment of the data processing system in this specification is based on the same inventive concept as the embodiment of the data processing method in this specification. Therefore, for specific implementation of the embodiment, references can be made to the above-mentioned corresponding implementation of the data processing method, and repeated parts are omitted for simplicity.

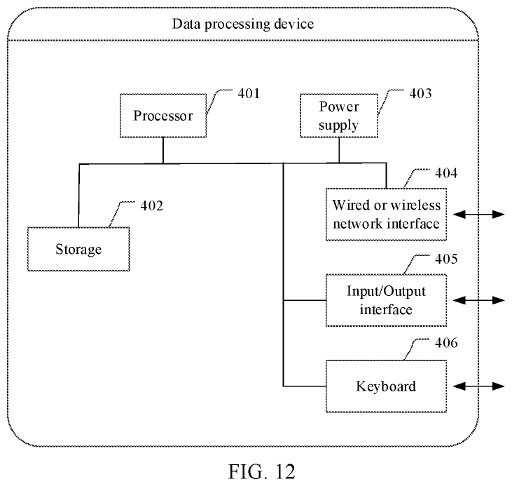

Further, corresponding to the described data processing method, based on the same technical concept, one or more embodiments of this specification further provide a data processing device. The device is configured to perform the data processing method. FIG. 12 is a schematic diagram illustrating a structure of a data processing device, according to one or more embodiments of this specification.

As shown in FIG. 12, the data processing device can vary greatly with configuration or performance, and can include one or more processors 401 and a storage 402. The storage 402 can store one or more storage applications or data. The storage 402 can be a temporary storage or persistent storage. The application stored in the storage 402 can include one or more modules (not shown in the figure), and each module can include a series of computer-executable instructions in the data processing device. Still further, the processor 401 can be configured to communicate with the storage 402 to execute a series of computer-executable instructions in the storage 402 on the data processing device. The data processing device can further include one or more power supplies 403, one or more wired or wireless network interfaces 404, one or more input/output interfaces 405, one or more keyboards 406, etc.

In a specific embodiment, the data processing device includes a storage and one or more programs. The one or more programs are stored in the storage. The one or more programs can include one or more modules, and each module can include a series of computer-executable instructions in the data processing device. Through configuration, one or more processors execute the following computer-executable instructions included in the one or more programs: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

According to the data processing device provided in one or more embodiments of this specification, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

It is worthwhile to note that the embodiment of the data processing device in this specification is based on the same inventive concept as the embodiment of the data processing method in this specification. Therefore, for specific implementation of the embodiment, references can be made to the above-mentioned corresponding implementation of the data processing method, and repeated parts are omitted for simplicity.

Further, corresponding to the described data processing method, based on the same technical concept, one or more embodiments of this specification further provide a storage medium, configured to store computer-executable instructions. In a specific embodiment, the storage medium can be a USB flash drive, an optical disc, a hard disk, etc. When being executed by a processor, the computer-executable instructions stored in the storage medium can implement the following procedure: determining a receipt obtaining manner corresponding to a payment voucher, where the payment voucher is generated after payment processing of a target transaction is performed based on a reimbursement code; obtaining, in the receipt obtaining manner, an electronic receipt that matches the payment voucher; and returning the electronic receipt and the payment voucher to an application platform on which an institution to which the reimbursement code belongs is settled, to process the electronic receipt and the payment voucher on the application platform.

When the computer-executable instructions stored in the storage medium provided in one or more embodiments of this specification are executed by the processor, the electronic receipt that matches the payment voucher generated by performing the payment operation based on the reimbursement code is obtained, and the electronic receipt and the payment voucher are returned to the application platform on which the institution is settled. For a reimbursement scenario, the receipt is automatically returned without requiring the institution member to perform processing such as receipt pasting. Because the institution member cannot tamper with the payment voucher, the electronic receipt can be proved trusted by using the payment voucher, to evidence authenticity of the electronic receipt, thereby reducing a workload of verifying the authenticity of the electronic receipt by an auditor. In addition, the electronic receipt and the payment voucher are directly returned to the application platform on which the institution is settled, without requiring the institution and the application platform to exchange the receipt. Therefore, reimbursement efficiency and reimbursement-related user experience are greatly improved.

It should be noted that the embodiments of the storage medium in this specification are based on the same inventive concept as the embodiments of the data processing method in this specification. Therefore, for specific implementation of the embodiments of the storage medium, references can be made to the above-mentioned corresponding implementation of the data processing method, and repeated parts are omitted for simplicity.

Specific embodiments of the present specification are described above. Other embodiments fall within the scope of the appended claims. In some cases, actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers obtain a corresponding hardware circuit structure by programming an improved method procedure into a hardware circuit. Therefore, a method procedure can be improved using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. A storage controller can also be implemented as a part of the control logic of the storage. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

The system, apparatus, module, or unit illustrated in the previous embodiments can be specifically implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when the embodiments of this specification are implemented, functions of the units can be implemented in one or more pieces of software and/or hardware. A person skilled in the art should understand that one or more embodiments of this specification can be provided as a method, a system, or a computer program product. Therefore, one or more embodiments of this specification can use a form of hardware only embodiments, software only embodiments, or embodiments with a combination of software and hardware. In addition, a form of a computer program product that is implemented on one or more computer-usable storage media (including but not limited to a disk storage, a CD-ROM, an optical storage, etc.) that include computer-usable program code can be used in this specification.

This specification is described with reference to the flowcharts and/or block diagrams of the method, the device (system), and the computer program product according to the embodiments of this specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

These computer program instructions can alternatively be loaded onto the computer or another programmable data processing device, so a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer readable medium includes persistent, non-persistent, movable, and unmovable media that can store information by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in this specification, the computer readable medium does not include transitory media such as a modulated data signal and carrier.

It should be further noted that, the terms “include”, “comprise”, or any other variant thereof are intended to cover a non-exclusive inclusion, so a process, a method, a product or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product or device that includes the element.

The one or more embodiments of this specification can be described in the general context of computer-executable instructions executed by a computer, for example, a program module. Generally, the program module includes a routine, a program, an object, a component, a data structure, etc. for executing a specific task or implementing a specific abstract data type. One or more embodiments of this specification can also be practiced in distributed computing environments. In the distributed computing environments, tasks are performed by remote processing devices that are connected through a communication network. In the distributed computing environments, the program module can be located in both local and remote computer storage media including storage devices.

The embodiments in this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to this specification. Any modification, equivalent replacement, or improvement made without departing from the spirit and principle of this specification shall fall within the scope of the claims in this specification.

1. A data processing method, comprising:
determining a receipt obtaining manner corresponding to a payment voucher, wherein the payment voucher is generated after payment processing of a target transaction is performed based on a reimbursement code;
obtaining, in the receipt obtaining manner, an electronic receipt that matches the payment voucher; and
returning the electronic receipt and the payment voucher to an application platform on which an institution to which the reimbursement code belongs is settled, to process the electronic receipt and the payment voucher on the application platform.

2. The method according to claim 1, wherein the determining a receipt obtaining manner corresponding to a payment voucher comprises:
obtaining information about a transaction participant corresponding to the target transaction from the payment voucher;
determining, based on the information about the transaction participant, whether the transaction participant has activated an automatic receipt return service; and
upon determining that transaction participant has activated an automatic receipt return service, determining that the receipt obtaining manner is a first obtaining manner; or
upon determining that transaction participant has not activated an automatic receipt return service, determining that the receipt obtaining manner is a second obtaining manner.

3. The method according to claim 2, wherein the receipt obtaining manner is the first obtaining manner, and the obtaining, in the receipt obtaining manner, an electronic receipt that matches the payment voucher comprises:
determining institution information of the institution to which the reimbursement code belongs; sending a first receipt obtaining request to the transaction participant based on the institution information and determined voucher identification information of the payment voucher; receiving the electronic receipt and the voucher identification information that are sent by the transaction participant; and determining the received electronic receipt as the electronic receipt that matches the payment voucher corresponding to the voucher identification information; or
receiving an electronic receipt and voucher identification information that are sent by the transaction participant of the target transaction; and determining the received electronic receipt as an electronic receipt that matches a payment voucher corresponding to the voucher identification information, wherein the electronic receipt is generated based on a second receipt obtaining request sent by an institution member who initiates the target transaction, and the second receipt obtaining request comprises the voucher identification information.

4. The method according to claim 2, wherein the receipt obtaining manner is the second obtaining manner, and the obtaining, in the receipt obtaining manner, an electronic receipt that matches the payment voucher comprises:
receiving an electronic receipt sent by the transaction participant of the target transaction; performing matching processing on the electronic receipt and the payment voucher in a preset first matching manner; and upon determining that matching succeeds, determining the electronic receipt as the electronic receipt that matches the payment voucher, wherein the electronic receipt is generated based on a third receipt obtaining request sent by an institution member who initiates the target transaction, and the third receipt obtaining request is sent by scanning an electronic receipt application code provided by the transaction participant of the target transaction.

5. The method according to claim 2, wherein the receipt obtaining manner is the second obtaining manner, and the obtaining, in the receipt obtaining manner, an electronic receipt that matches the payment voucher comprises:
receiving a first association request sent by a first terminal device of an institution member who initiates the target transaction, wherein the first association request comprises an electronic receipt and voucher identification information, and the electronic receipt is obtained by the first terminal device from the transaction participant of the target transaction based on a receipt application operation of the institution member, or the electronic receipt is generated based on a paper receipt of the target transaction and is uploaded by the institution member; and
determining the electronic receipt in the first association request as an electronic receipt that matches a payment voucher corresponding to the voucher identification information.

6. The method according to claim 2, wherein the receipt obtaining manner is the second obtaining manner, and the obtaining, in the receipt obtaining manner, an electronic receipt that matches the payment voucher comprises:
receiving a second association request sent by a first terminal device of an institution member who initiates the target transaction, wherein the second association request comprises an electronic receipt and voucher identification information, and the electronic receipt is not generated based on the target transaction and is uploaded by the institution member;
obtaining a corresponding payment voucher based on the voucher identification information;
performing matching processing on the electronic receipt and the payment voucher in a preset second matching manner; and
upon determining that matching processing succeeds, determining the electronic receipt as the electronic receipt that matches the payment voucher.

7. The method according to claim 1, wherein the returning the electronic receipt and the payment voucher to an application platform on which an institution to which the reimbursement code belongs is settled comprises:
sending, based on voucher information of the payment voucher and receipt information of the electronic receipt, prompt information to the application platform on which the institution to which the reimbursement code belongs is settled; and
upon determining that a specified request sent by the application platform is received, returning the electronic receipt and the payment voucher to the application platform on which the institution to which the reimbursement code belongs is settled.

8. The method according to claim 7, wherein the sending, based on voucher information of the payment voucher and receipt information of the electronic receipt, prompt information to the application platform on which the institution to which the reimbursement code belongs is settled comprises:
establishing an association relationship between the electronic receipt and the payment voucher at a preset first time interval based on receipt information of each electronic receipt and voucher information of a matching payment voucher that are obtained in a corresponding first time interval; and
sending, based on the association relationship, the prompt information to the application platform on which the institution to which the reimbursement code belongs is settled.

9. (canceled)

10. (canceled)

11. (canceled)

12. (canceled)

13. (canceled)

14. (canceled)

15. (canceled)

16. A data processing device, comprising:
a memory and a processor, wherein the memory stores executable instructions that, in response to execution by the processor, cause the processor to:
determine a receipt obtaining manner corresponding to a payment voucher, wherein the payment voucher is generated after payment processing of a target transaction is performed based on a reimbursement code;
obtain, in the receipt obtaining manner, an electronic receipt that matches the payment voucher; and
return the electronic receipt and the payment voucher to an application platform on which an institution to which the reimbursement code belongs is settled, to process the electronic receipt and the payment voucher on the application platform.

17. A non-transitory computer-readable storage medium, comprising instructions stored therein that, when executed by a processor of a computer device, cause the processor to:
determine a receipt obtaining manner corresponding to a payment voucher, wherein the payment voucher is generated after payment processing of a target transaction is performed based on a reimbursement code;
obtain, in the receipt obtaining manner, an electronic receipt that matches the payment voucher; and
return the electronic receipt and the payment voucher to an application platform on which an institution to which the reimbursement code belongs is settled, to process the electronic receipt and the payment voucher on the application platform.
